(19) United States
(12) Patent Application Publication
(10) Pub. No.: US 2021/0214596 A1
(43) Pub. Date: Jul. 15, 2021

(54) ABRASIVE ARTICLE AND METHOD OF USE

(71) Applicants: SAINT-GOBAIN ABRASIVES, INC., Worcester, MA (US); SAINT-GOBAIN ABRASIFS, Conflans-Sainte-Honorine (FR)

(72) Inventors: Ramanujam VEDANTHAM, Shrewsbury, MA (US); Alexandre TEMPERELLI, Boston, MA (US)

(21) Appl. No.: 17/141,845

(22) Filed: Jan. 5, 2021

Related U.S. Application Data
(60) Provisional application No. 62/957,626, filed on Jan. 6, 2020.

(51) Int. Cl. C09K 3/14; C03C 14/00; C03C 3/091

(52) U.S. Cl. CPC C09K 3/1409; C03C 3/091; C03C 14/004

(57) ABSTRACT

An abrasive article including a first abrasive body coupled to a substrate, the first abrasive body having abrasive particles including a superabrasive and a bond material including a vitreous material and a second abrasive body coupled to the substrate, the second abrasive body having abrasive particles including a superabrasive and a bond material including at least one non-vitreous phase material, and as wear rate differential between the first abrasive body and second abrasive body of at least 0.08 cc.

### CROSS REFERENCE TO RELATED APPLICATION(S)

This application claims priority under 35 U.S.C. § 119(e) to U.S. Provisional Application No. 62/957,626, entitled “ABRASIVE ARTICLE AND METHOD OF USE,” by Ramanujam VEDANTHAM et al., filed Jan. 6, 2020, which is assigned to the current assignees hereof and incorporated by reference in its entirety.

### BACKGROUND

### Field of the Disclosure

The following is directed to an abrasive article, and particularly, an abrasive article including bonded abrasive segments.

### Description of the Related Art

A variety of abrasive tools have been developed over the past century for various industries for the general function of removing material from a workpiece, including for example, sawing, drilling, polishing, cleaning, carving, and grinding. In the production of electronic devices, the surface of a wafer may be ground to prepare for the deposition of electronic devices thereon. Additionally, the back surface of the wafer may be ground after the formation of electronic devices and prior to dicing. Generally, the article utilize to conduct certain grinding processes are grindstones, which typically include abrasive segments.

The industry continues to demand improved grindstone materials, capable of achieving improved grinding performance.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a portion of an abrasive article according to an embodiment.

FIG. 2 includes an illustration of a portion of an abrasive article according to an embodiment.

### DETAILED DESCRIPTION

The following description in combination with the figures is provided to assist in understanding the teachings provided herein. The following disclosure will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

The following is directed toward abrasive articles, and more particularly, an abrasive article that includes one or more abrasive bodies, particularly, abrasive bodies of different abrasive characteristics. The abrasive bodies can be in the form of bonded abrasive bodies, having abrasive particles contained within a three dimensional volume of bond material. The abrasive article may be suitable for grinding a workpiece, and particularly suited for grinding of hard materials, and more particularly, hard, single crystalline materials, such a sapphire or silicon carbide wafers.

The abrasive articles of the embodiments herein may be utilized in certain material removal operations. For example the abrasive article can be utilized in a material removal operation where the process includes removing material from one or more wafers simultaneously by moving the abrasive article relative to the one or more wafers. In certain instances, the process of moving the abrasive article relative to the one or more wafers can include rotating the abrasive article relative to the one or more wafers, which may be held in a stationary position. In other instances, the process of moving the abrasive article relative to the one or more wafers can include rotating the plurality of wafers relative to the abrasive article, which may be held in a stationary position. It will be appreciated in such processes the relative movement between the abrasive article can include can include movement of the abrasive article and/or one or more wafers relative to each other.

In an embodiment, an abrasive article 100 can include a first abrasive body 103 and a second abrasive body 104 coupled to a major planar surface 102 of a substrate 101. In an embodiment the abrasive article can comprise a plurality of abrasive bodies including a plurality of first abrasive bodies 103 and a plurality of second abrasive bodies 104.

In an embodiment, the first abrasive body and second abrasive body can have at least one abrasive characteristic that are different, wherein the abrasive characteristic is selected from the group of bond composition, bond content, porosity content, pore size distribution, average pore size, average abrasive particle size, abrasive particle composition, or any combination thereof. It is believed that the selection of certain properties for the first abrasive body and the second abrasive body may lead to improved performance of the abrasive article.

In an embodiment, the first abrasive body can comprise abrasive particles in a bond material.

In an embodiment, the first abrasive body can comprise a particular type of abrasive particles that may facilitate improved performance and/or manufacturing of the abrasive article. In an embodiment the first abrasive body can include abrasive particles comprising an oxide, carbide, nitride, boride, diamond. In an embodiment the first abrasive body can include abrasive particles comprising superabrasive particles. In an embodiment the first abrasive body can include abrasive particles comprising diamond.

In an embodiment, the first abrasive body can include a particular content of abrasive particles that may facilitate improved performance and/or manufacturing of the abrasive article.

In an embodiment, the first abrasive body can include a first content of abrasive particles of at least 10 vol % for a total volume of the first abrasive body or at least 12 vol % or at least 14 vol % or at least 16 vol % or at least 18 vol % or at least 20 vol % for a total volume of the first abrasive body. In an embodiment, the first abrasive body can include a first content of abrasive particles not greater than 30 vol % for a total volume of the first abrasive body or not greater than 28 vol % or not greater than 26 vol % or not greater than 24 vol % or not greater than 22 vol % for a total volume of the first abrasive body. It will be appreciated that the first content of abrasive particles may be between any of the minimum and maximum values noted above, including for example, but not limited to at least 12 vol % and not greater than 24 vol % or at least 18 vol % and not greater than 22 vol %.

In an embodiment, the first abrasive body can include a particular porosity that may facilitate improved performance and/or manufacturing of the abrasive article. In an embodiment, the first abrasive body can include a porosity of at least 50 vol % or at least 52 vol % or at least 54 vol % or at least 56 vol % or at least 58 vol % for a total volume of the first abrasive body. In an embodiment, the first abrasive body can include a porosity of not greater than 70 vol % not greater than 68 vol % or not greater than 66 vol % or not greater than 64 vol % or not greater than 62 vol % for a total volume of the first abrasive body. It will be appreciated that the porosity of the first abrasive body may be between any of the minimum and maximum values noted above, including for example, but not limited to at least 50 vol % and not greater than 66 vol % or at least 52 vol % and not greater than 70 vol %.

In an embodiment, the first abrasive body can include a particular bond material that may facilitate improved performance and/or manufacturing of the abrasive article. In an embodiment the first abrasive body can include a bond material comprising a vitreous bond material, a metal bond material, or a resin bond material. In an embodiment the first abrasive body can include a bond material comprising a vitreous bond material. In an embodiment the first abrasive body can include a bond material consisting of a vitreous bond material.

In an embodiment, the first abrasive body can include a particular content of bond material that may facilitate improved performance and/or manufacturing of the abrasive article. In an embodiment, the first abrasive body can include a first content of bond material of at least 5 vol % or at least 6 vol % or at least 8 vol % for a total volume of the first abrasive body or at least 10 vol % for a total volume of the first abrasive body. In an embodiment, the first abrasive body can include a first content of bond material not greater than not greater than 20 vol % or not greater than 18 vol % or not greater than 16 vol % or not greater than 14 vol % for a total volume of the first abrasive body. It will be appreciated that the first content of bond material may be between any of the minimum and maximum values noted above, including for example, but not limited to at least 5 vol % and not greater than 20 vol % or at least 6 vol % and not greater than 18 vol %.

In an embodiment, the first abrasive body may include filler. In an embodiment, the first abrasive body may include a particular type of filler that may facilitate improved performance and/or manufacturing of the abrasive article. In an embodiment the first abrasive body may include filler comprising a particulate, a fiber, an inorganic material, an organic material or a combination thereof. In an embodiment, the first abrasive body may include filler comprising a wear resistant particle. In an embodiment, the first abrasive body may include filler comprising tungsten, iron, titanium, diamond, a carbide, a nitride, a boride, an oxide, or any combination thereof. In an embodiment, the first abrasive body may include filler comprising alumina spheres.

In an embodiment, the first abrasive body can include particular content of filler that may facilitate improved performance and/or manufacturing of the abrasive article. In an embodiment, the first abrasive body can include a first content of filler of at least 0.5 vol or at least 1 vol % or at least 2 vol % or at least 4 vol % or at least 6 vol %. In an embodiment, the first abrasive body can include a first content of filler not greater than not greater than not greater than 20 vol % or not greater than 18 vol % or not greater than 16 vol % or not greater than 14 vol % or not greater than 12 vol %. It will be appreciated that the first content of filler may be between any of the minimum and maximum values noted above, including for example, but not limited to at least 1 vol % and not greater than 20 vol % or at least 6 vol % and not greater than 18 vol %.

In an embodiment, the second abrasive body can comprise abrasive particles in a bond material.

In an embodiment, the second abrasive body can comprise a particular type of abrasive particles that may facilitate improved performance and/or manufacturing of the abrasive article. In an embodiment the second abrasive body can include abrasive particles comprising an oxide, carbide, nitride, boride, diamond. In an embodiment the second abrasive body can include abrasive particles comprising superabrasive particles. In an embodiment the second abrasive body can include abrasive particles comprising diamond.

In an embodiment, the second abrasive body can include a particular content of abrasive particles that may facilitate improved performance and/or manufacturing of the abrasive article. In an embodiment, the second abrasive body can include a second content of abrasive particles of at least 0.5 vol % for a total volume of the second abrasive body or at least 1 vol % for a total volume of the second abrasive body. In an embodiment, the second abrasive body can include a second content of abrasive of not greater than 8 vol % for a total volume of the second abrasive body or not greater than 7 vol % or not greater than 6 vol % or not greater than 5 vol % or not greater than 4 vol % or not greater than 3 vol % for a total volume of the second abrasive body. It will be appreciated that the second content of abrasive particles may be between any of the minimum and maximum values noted above, including for example, but not limited to at least 0.5 vol % and not greater than 7 vol % or at least 1 vol % and not greater than 6 vol %.

In an embodiment, the second abrasive body can include a particular porosity that may facilitate improved performance and/or manufacturing of the abrasive article. In an embodiment, the second abrasive body can include a porosity 45 vol % for a total volume of the second abrasive body or at least 50 vol % or at least 55 vol % or at least 60 vol % or at least 63 vol % or at least 66 vol % and for a total volume of the second abrasive body. In an embodiment, the second abrasive body can include a porosity not greater than 80 vol % for a total volume of the second abrasive body or not greater than 78 vol % or not greater than 75 vol % or and not greater than 72 vol % or not greater than 70 vol %. It will be appreciated that the porosity of the second abrasive body may be between any of the minimum and maximum values noted above, including for example, but not limited to at least 50 vol % and not greater than 78 vol % or at least 55 vol % and not greater than 70 vol %.

In an embodiment, the second abrasive body can include a particular content of bond material that may facilitate improved performance and/or manufacturing of the abrasive article. In an embodiment, the second abrasive body can include a second content of bond material of at least 20 vol % for a total volume of the second abrasive body or at least 22 vol % or at least 25 vol % or at least 28 vol %. In an embodiment, the second abrasive body can include a second content of bond material of not greater than 45 vol % for a total volume of the second abrasive body or not greater than 40 vol % or not greater than 38 vol % or not greater than 36 vol % or not greater than 32 vol % for a total volume of the second abrasive body. It will be appreciated that the second content of bond material may be between any of the minimum and maximum values noted above, including for example, but not limited to at least 20 vol % and not greater than 40 vol % or at least 22 vol % and not greater than 45 vol %.

In an embodiment, the second abrasive body may include filler. In an embodiment, the second abrasive body may include a particular type of filler that may facilitate improved performance and/or manufacturing of the abrasive article. In an embodiment the second abrasive body may include filler comprising a particulate, a fiber, an inorganic material, an organic material or a combination thereof. In an embodiment, the second abrasive body may include filler comprising a wear resistant particle. In an embodiment, the second abrasive body may include filler comprising tungsten, iron, titanium, diamond, a carbide, a nitride, a boride, an oxide, or any combination thereof. In an embodiment, the second abrasive body may include filler comprising alumina spheres.

In an embodiment, the second abrasive body can include particular content of filler that may facilitate improved performance and/or manufacturing of the abrasive article. In an embodiment, the second abrasive body can include a second content of filler of not greater than 10 vol % for a total volume of the second abrasive body or not greater than 8 vol % for a total volume of the second abrasive body or not greater than 6 vol % for a total volume of the second abrasive body or not greater than 4 vol % for a total volume of the second abrasive body or not greater than 2 vol %. In an embodiment, the second abrasive body may be free of filler wherein the second abrasive body is free of filler. It will be appreciated that the second content of filler may be between any of the minimum and maximum values noted above, including for example, but not limited to at least 1 vol % and not greater than 20 vol % or at least 6 vol % and not greater than 18 vol %.

In an embodiment, the first abrasive body may have a particular wear rate index that may facilitate improved performance and/or manufacturing of the abrasive article. The wear rate index can be determined determined by rotating (150 RPM) a puck made formed from the same materials of the abrasive body against silicon carbide paper (320 grit) for five seconds with a force of 30N and measuring the amount of material removed. In an embodiment, the first abrasive body can have a wear rate index of at least 0.05 cc or at least 0.06 cc or at least 0.07 cc or at least 0.08 cc or at least 0.09 cc or at least 0.10 cc. In an embodiment, the first abrasive body can have a wear rate index of not greater than 1.0 cc or not greater than 0.90 cc or not greater than 0.80 cc or not greater than 0.60 cc or not greater than 0.50 cc or not greater than 0.40 cc or not greater than 0.30 cc or not greater than 0.20 cc. It will be appreciated that the wear rate index of the first abrasive body may be between any of the minimum and maximum values noted above, including for example, but not limited to, at least 0.1 cc and not greater than 0.9 cc.

In an embodiment, the second abrasive body may have a particular wear rate index that may facilitate improved performance and/or manufacturing of the abrasive article. In an embodiment, the second abrasive body can have a wear rate index of at least 0.25 cc or at least 0.26 cc or at least 0.27 cc or at least 0.28 cc or at least 0.29 cc or at least 0.30 cc. In an embodiment, the second abrasive body can have a wear rate index of not greater than of not greater than 1.0 cc or not greater than 0.90 cc or not greater than 0.80 cc or not greater than 0.60 cc or not greater than 0.50 cc. It will be appreciated that the wear rate index of the second abrasive body may be between any of the minimum and maximum values noted above, including for example, but not limited to, at least 0.25 cc and not greater than 0.9 cc.

In an embodiment, the abrasive article may have a particular wear rate differential between the first abrasive body and the second abrasive body that may facilitate improved performance and/or manufacturing of the abrasive article. In an embodiment, the wear rate differential can be at least 0.08 cc or at least 0.10 cc or at least 0.15 cc or at least 0.18 cc or at least 0.20 cc. In an embodiment, the wear rate differential can be at least 5% or at least 10% or at least 15%. In an embodiment, the wear rate differential can be not greater than 1.0 cc or not greater than 0.90 cc or not greater than 0.80 cc or not greater than 0.60 cc or not greater than 0.50 cc or not greater than 0.40 cc. In an embodiment, the wear rate differential can be not greater than 200% of the lower wear rate. It will be appreciated that the wear rate differential may be between any of the minimum and maximum values noted above, including for example, but not limited to, at least at least 0.08 cc and not greater than 200% of the lower wear rate.

In an embodiment, the abrasive article may have a particular wear rate differential between the first abrasive body and the second abrasive body that may facilitate improved performance and/or manufacturing of the abrasive article. In an embodiment, the wear rate differential can be at least 0.08 cc or at least 0.10 cc or at least 0.15 cc or at least 0.18 cc or at least 0.20 cc. In an embodiment, the wear rate differential can be at least 5% or at least 10% or at least 15%. In an embodiment, the wear rate differential can be not greater than 1.0 cc or not greater than 0.90 cc or not greater than 0.80 cc or not greater than 0.60 cc or not greater than 0.50 cc or not greater than 0.40 cc. In an embodiment, the wear rate differential can be not greater than 200% of the lower wear rate. It will be appreciated that the wear rate differential may be between any of the minimum and maximum values noted above, including for example, but not limited to, at least at least 0.08 cc and not greater than 200% of the lower wear rate.

In an embodiment, the abrasive article may have a particular average compressive stress at maximum load that may facilitate improved performance and/or manufacturing of the abrasive article. In an embodiment, the average compressive stress at maximum load can be at least 50 MPa or at least 60 MPa or at least 70 MPa or at least 80 MPa a or at least 90 MPa or at least 100 MPa or at least 110 MPa or at least 120 MPa or at least 130 MPa or at least 140 MPa or at least 150 MPa. In an embodiment, the average compressive stress at maximum load can be not greater than 450 MPa or not greater than 400 MPa or not greater than 380 MPa or not greater than 350 MPa or not greater than 320 MPa or not greater than 300 MPa or not greater than 280 MPa or not greater than 250 MPa or not greater than 220 MPa or and not greater than 200 MPa. It will be appreciated that the average compressive stress at maximum load may be between any of the minimum and maximum values noted above, including for example, but not limited to, at least at least 50 MPA and not greater than 200 MPa.

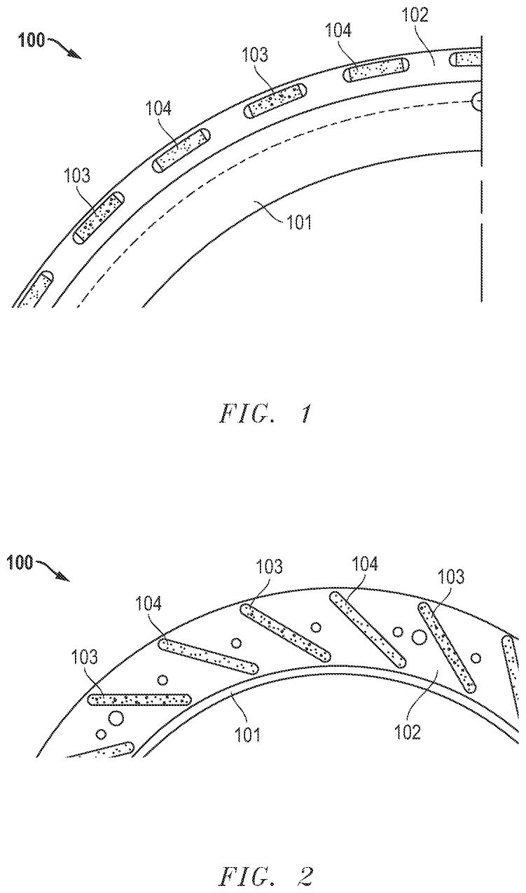

The first abrasive bodies and second abrasive bodies can be arranged in a radially-alternating arrangement relative to each other as provided in either of FIG. 1 or 2. It will be appreciated that other arrangements of the abrasive bodies can be utilized. For example, it may be suitable to have alternating groupings of the first and second bodies. Such that a first grouping includes a plurality of the first abrasive bodies, a second grouping includes a plurality of the second abrasive bodies, and wherein the groupings are alternating relative to each other. The groupings may contain any number of abrasive bodies. The groupings of first abrasive bodies can have the same or a different number of abrasive bodies as the groupings of second abrasive bodies. Abrasive bodies within a grouping can be immediately adjacent each other without any other intervening abrasive body of a different type there between. The abrasive bodies may be arranged randomly. The bodies may be oriented randomly, or non-randomly. Non-limiting examples of non-random orientations include the fanned orientation of FIG. 2 and the circumferential orientation of FIG. 1.

In an embodiment, the plurality of first abrasive bodies can provide a first surface area SA1 and the plurality of second abrasive bodies provides a second abrasive surface area SA2. In an embodiment, the abrasive article can include a particular ratio of SA1/SA2 that provides improved performance and/or manufacturing of the abrasive article. In an embodiment, SA1/SA2 can be at least 0.1, or at least 0.2, or at least 0.3, or at least 0.4, or at least 0.5. In an embodiment, SA1/SA2 can be not greater than 10, or not greater than 9, or not greater than 8, or not greater than 7, or not greater than 6, or not greater than 5. It will be appreciated that SA1/SA2 can be between any of the minimum and maximum values noted above, including for example, but not limited to at least 0.1 and not greater than 10, at least 0.3 and not greater than 7, or at least 0.5 and not greater than 8.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. An abrasive article comprising: a first abrasive body coupled to a substrate, wherein the first abrasive body comprises: a first content of abrasive particles of at least 10 vol % and not greater than 30 vol % for a total volume of the first abrasive body; a first content of porosity of at least 50 vol % and not greater than 70 vol % for a total volume of the first abrasive body; a first content of bond material of at least 5 vol % and not greater than 20 vol % for a total volume of the first abrasive body, wherein the bond material comprises a vitreous material; and a second abrasive body coupled to the substrate, wherein the second abrasive body comprises: a bond material comprising metal; and at least one of: a second content of abrasive particles in the second abrasive body different from the first content of abrasive particles of the first abrasive body; a second content of porosity in the second abrasive body that is different from the first content of porosity of the first abrasive body; or a second content of bond material in the second abrasive body that is different from the first content of bond material of the first abrasive body.

Embodiment 2. An abrasive article comprising: a first abrasive body coupled to a substrate, wherein the first abrasive body comprises abrasive particles including a abrasive and a bond material comprising a vitreous material; a second abrasive body coupled to the substrate, wherein the second abrasive body comprises abrasive particles including a abrasive and a bond material comprising at least one non-vitreous phase material; and a wear rate differential between the first abrasive body and second abrasive body of at least 0.08 cc.

Embodiment 3. An abrasive article comprising: a substrate comprising a first surface; a plurality of abrasive bodies attached to the first surface, wherein the plurality of abrasive bodies comprises: a first abrasive body; and a second abrasive body, wherein the first abrasive body and second abrasive body have at least one abrasive characteristic that are different, wherein the abrasive characteristic is selected from the group of bond composition, bond content, porosity content, pore size distribution, average pore size, average abrasive particle size, abrasive particle composition, or any combination thereof; and wherein the plurality of abrasive bodies includes an alternating arrangement of the first abrasive body and the second abrasive body.

Embodiment 4. An abrasive article comprising: a substrate comprising a first surface; a plurality of abrasive bodies attached to the first surface, wherein the plurality of abrasive bodies comprises: a first abrasive body; and a second abrasive body, wherein the first abrasive body and second abrasive body have at least one abrasive characteristic that are different, wherein the abrasive characteristic is selected from the group of bond composition, bond content, porosity content, pore size distribution, average pore size, average abrasive particle size, abrasive particle composition, or any combination thereof; and wherein the first abrasive body and the second abrasive body have at least one of: a wear rate differential between the first abrasive body and second abrasive body of at least 0.08 cc; and an average compressive stress at maximum load of at least 50 MPa.

Embodiment 5. The abrasive article of any of the preceding embodiments, wherein the first abrasive body comprises: a first content of abrasive particles of at least 12 vol % and not greater than 28 vol % for a total volume of the first abrasive body; a first content of porosity of at least 52 vol % and not greater than 68 vol % for a total volume of the first abrasive body; and a first content of bond material of at least 6 vol % and not greater than 18 vol % for a total volume of the first abrasive body, wherein the bond material comprises a vitreous material.

Embodiment 6. The abrasive article of any of the preceding embodiments, wherein the first abrasive body comprises a first content of abrasive particles of at least 10 vol % for a total volume of the first abrasive body or at least 12 vol % or at least 14 vol % or at least 16 vol % or at least 18 vol % or at least 20 vol % for a total volume of the first abrasive body.

Embodiment 7. The abrasive article of any of the preceding embodiments, wherein the first abrasive body comprises a first content of abrasive particles not greater than 30 vol % for a total volume of the first abrasive body or not greater than 28 vol % or not greater than 26 vol % or not greater than 24 vol % or not greater than 22 vol % for a total volume of the first abrasive body.

Embodiment 8. The abrasive article of any of the preceding embodiments, wherein the first abrasive body comprises a first content of porosity of at least 50 vol % or at least 52 vol % or at least 54 vol % or at least 56 vol % or at least 58 vol % for a total volume of the first abrasive body.

Embodiment 9. The abrasive article of any of the preceding embodiments, wherein the first abrasive body comprises a first content of porosity of not greater than 70 vol % not greater than 68% or not greater than 66 vol % or not greater than 64 vol % or not greater than 62 vol % for a total volume of the first abrasive body.

Embodiment 10. The abrasive article of any of the preceding embodiments, wherein the first abrasive body comprises a first content of bond material of at least 5 vol % or at least 6 vol % or at least 8 vol % for a total volume of the first abrasive body or at least 10 vol % for a total volume of the first abrasive body.

Embodiment 11. The abrasive article of any of the preceding embodiments, wherein the first abrasive body comprises a first content of bond material of not greater than 20 vol % or not greater than 18 vol % or not greater than 16 vol % or not greater than 14 vol % for a total volume of the first abrasive body.

Embodiment 12. The abrasive article of any of the preceding embodiments, wherein the first abrasive body comprises a first content of a filler of at least 0.5 vol % or at least 1 vol % or at least 2 vol % or at least 4 vol % or at least 6 vol %.

Embodiment 13. The abrasive article of any of the preceding embodiments, wherein the first abrasive body comprises a first content of a filler of not greater than 20 vol % or not greater than 18 vol % or not greater than 16 vol % or not greater than 14 vol % or not greater than 12 vol %.

Embodiment 14. The abrasive article of any of the preceding embodiments, wherein the first abrasive body comprises filler comprising a particulate, a fiber, an inorganic material, an organic material or a combination thereof.

Embodiment 15. The abrasive article of any of the preceding embodiments, wherein the first abrasive body comprises filler comprising a wear resistant particle.

Embodiment 16. The abrasive article of any of the preceding embodiments, wherein the first abrasive body comprises a filler selected from the group consisting of tungsten, iron, titanium, diamond, a carbide, a nitride, a boride, an oxide, or any combination thereof.

Embodiment 17. The abrasive article of any of the preceding embodiments, wherein the first abrasive body comprises a filler comprising alumina spheres.

Embodiment 18. The abrasive article of any of the preceding embodiments, wherein the second abrasive body comprises: a second content of abrasive particles of at least 0.5 vol % and not greater than 8 vol % for a total volume of the second abrasive body; a second content of porosity of at least 45 vol % and not greater than 80 vol % for a total volume of the second abrasive body; and a second content of bond material of at least 20 vol % and not greater than 45 vol % for a total volume of the second abrasive body.

Embodiment 19. The abrasive article of any of the preceding embodiments, wherein the second abrasive body comprises a second content of abrasive particles of at least 0.5 vol % for a total volume of the second abrasive body or at least 1 vol % for a total volume of the second abrasive body.

Embodiment 20. The abrasive article of any of the preceding embodiments, wherein the second abrasive body comprises a second content of abrasive particles of not greater than 8 vol % for a total volume of the second abrasive body or not greater than 7 vol % or not greater than 6 vol % or not greater than 5 vol % or not greater than 4 vol % or not greater than 3 vol % for a total volume of the second abrasive body.

Embodiment 21. The abrasive article of any of the preceding embodiments, wherein the second abrasive body comprises a second content of porosity of at least 45 vol % for a total volume of the second abrasive body or at least 50 vol % or at least 55 vol % or at least 60 vol % or at least 63 vol % or at least 66 vol % and for a total volume of the second abrasive body.

Embodiment 22. The abrasive article of any of the preceding embodiments, wherein the second abrasive body comprises a second content of porosity of not greater than 80 vol % for a total volume of the second abrasive body or not greater than 78 vol % or not greater than 75 vol % or and not greater than 72 vol % or not greater than 70 vol %.

Embodiment 23. The abrasive article of any of the preceding embodiments, wherein the second abrasive body comprises a second content of bond material of at least 20 vol % for a total volume of the second abrasive body or at least 22 vol % or at least 25 vol % or at least 28 vol %.

Embodiment 24. The abrasive article of any of the preceding embodiments, wherein the second abrasive body comprises a second content of bond material of not greater than 45 vol % for a total volume of the second abrasive body or not greater than 40 vol % or not greater than 38 vol % or not greater than 36 vol % or not greater than 32 vol % for a total volume of the second abrasive body.

Embodiment 25. The abrasive article of any of the preceding embodiments, wherein the second abrasive body comprises a second filler content of not greater than 10 vol % for a total volume of the second abrasive body or not greater than 8 vol % for a total volume of the second abrasive body or not greater than 6 vol % for a total volume of the second abrasive body or not greater than 4 vol % for a total volume of the second abrasive body or not greater than 2 vol %.

Embodiment 26. The abrasive article of any of the preceding embodiments, wherein the second abrasive body is free of filler.

Embodiment 27. The abrasive article of any of the preceding embodiments, wherein the second abrasive body comprises a filler comprising a particulate, a fiber, an inorganic material, an organic material or a combination thereof.

Embodiment 28. The abrasive article of any of the preceding embodiments, wherein the second abrasive body comprises filler comprising a wear resistant particle.

Embodiment 29. The abrasive article of any of the preceding embodiments, wherein the second abrasive body comprises a filler selected from the group consisting of tungsten, iron, titanium, diamond, a carbide, a nitride, a boride, an oxide, or any combination thereof.

Embodiment 30. The abrasive article of any of the preceding embodiments, wherein second first abrasive body comprises filler comprising alumina spheres.

Embodiment 31. The abrasive article of any of the preceding embodiments, wherein the abrasive article comprises: a wear rate differential between the first abrasive body and second abrasive body of at least 0.08 cc and not greater than 1.0 cc; and an average compressive stress at maximum load of at least 50 MPa and not greater than 500 MPa.

Embodiment 32. The abrasive article of any of the preceding embodiments, wherein the bond material of the first abrasive body comprises a vitreous bond material, a metal bond material, or a resin bond material.

Embodiment 33. The abrasive article of any of the preceding embodiments, wherein the bond material of the first abrasive body comprises a vitreous bond material.

Embodiment 34. The abrasive article of any of the preceding embodiments, wherein the bond material of the first abrasive body comprises a metal bond material.

Embodiment 35. The abrasive article of any of the preceding embodiments, wherein the bond material of the first abrasive body comprises a resin bond material.

Embodiment 36. The abrasive article of any of the preceding embodiments, wherein the bond material of the first abrasive body consists of a vitreous bond material.

Embodiment 37. The abrasive article of any of the preceding embodiments, wherein the first abrasive body comprises a wear rate index of at least 0.05 cc or at least 0.06 cc or at least 0.07 cc or at least 0.08 cc or at least 0.09 cc or at least 0.10 cc.

Embodiment 38. The abrasive article of any of the preceding embodiments, wherein the first abrasive body comprises a wear rate index of not greater than 1.0 cc or not greater than 0.90 cc or not greater than 0.80 cc or not greater than 0.60 cc or not greater than 0.50 cc or not greater than 0.40 cc or not greater than 0.30 cc or not greater than 0.20 cc.

Embodiment 39. The abrasive article of any of the preceding embodiments, wherein the bond material of the second abrasive body comprises a vitreous bond material, a metal bond material, or a resin bond material.

Embodiment 40. The abrasive article of any of the preceding embodiments, wherein the bond material of the second abrasive body comprises a vitreous bond material.

Embodiment 41. The abrasive article of any of the preceding embodiments, wherein the bond material of the second abrasive body comprises a non-vitreous bond material.

Embodiment 42. The abrasive article of any of the preceding embodiments, wherein the bond material of the second abrasive body comprises a metal bond material.

Embodiment 43. The abrasive article of any of the preceding embodiments, wherein the bond material of the second abrasive body comprises a resin bond material.

Embodiment 44. The abrasive article of any of the preceding embodiments, wherein the bond material of the second abrasive body consists of a metal bond material.

Embodiment 45. The abrasive article of any of the preceding embodiments, wherein the second abrasive body comprises a wear rate index of at least 0.25 cc or at least 0.26 cc or at least 0.27 cc or at least 0.28 cc or at least 0.29 cc or at least 0.30 cc.

Embodiment 46. The abrasive article of any of the preceding embodiments, wherein the second abrasive body comprises a wear rate index of not greater than 1.0 cc or not greater than 0.90 cc or not greater than 0.80 cc or not greater than 0.60 cc or not greater than 0.50 cc.

Embodiment 47. The abrasive article of any of the preceding embodiments, wherein the wear rate differential between the first abrasive body and the second abrasive body is not greater than 200% of the lower wear rate.

Embodiment 48. The abrasive article of any of the preceding embodiments, wherein the wear rate differential between the first abrasive body and the second abrasive body is at least 5% or at least 10% or at least 15%.

Embodiment 49. The abrasive article of any of the preceding embodiments, wherein the wear rate differential between the first abrasive body and the second abrasive body is at least 0.08 cc or at least 0.10 cc or at least 0.15 cc or at least 0.18 cc or at least 0.20 cc.

Embodiment 50. The abrasive article of any of the preceding embodiments, wherein the wear rate differential between the first abrasive body and the second abrasive body is not greater than 1.0 cc or not greater than 0.90 cc or not greater than 0.80 cc or not greater than 0.60 cc or not greater than 0.50 cc or not greater than 0.40 cc.

Embodiment 51. The abrasive article of any of the preceding embodiments, wherein the first abrasive body comprises an average compressive stress at maximum load of at least 50 MPa or at least 60 MPa or at least 70 MPa or at least 80 MPa a or at least 90 MPa or at least 100 MPa or at least 110 MPa or at least 120 MPa or at least 130 MPa or at least 140 MPa or at least 150.

Embodiment 52. The abrasive article of any of the preceding embodiments, wherein the first abrasive body comprises an average compressive stress at maximum load not greater than 450 MPa or not greater than 400 MPa or not greater than 380 MPa or not greater than 350 MPa or not greater than 320 MPa or not greater than 300 MPa or not greater than 280 MPa or not greater than 250 MPa or not greater than 220 MPa or and not greater than 200 MPa.

Embodiment 53. The abrasive article of any of the preceding embodiments, further comprising a plurality of abrasive bodies attached to a major planar surface of a substrate, wherein the plurality of abrasive bodies includes a plurality of first abrasive bodies and a plurality of second abrasive bodies, wherein the first and second abrasive bodies are arranged in a radial alternating manner relative to each other.

Embodiment 54. The abrasive article of any of the preceding embodiments, further comprising a plurality of abrasive bodies attached to a major planar surface of a substrate, wherein the plurality of abrasive bodies includes a plurality of first abrasive bodies and a plurality of second abrasive bodies, wherein the plurality of first abrasive bodies provides a first abrasive surface area SA1 and the plurality of second abrasive bodies provides a second abrasive surface area SA2, and wherein the first abrasive surface area to the second abrasive surface area, SA1/SA2, is at least 0.1, or at least 0.2, or at least 0.3, or at least 0.4, or at least 0.5.

Embodiment 55. The abrasive article of any of the preceding embodiments, further comprising a plurality of abrasive bodies attached to a major planar surface of a substrate, wherein the plurality of abrasive bodies includes a plurality of first abrasive bodies and a plurality of second abrasive bodies, wherein the plurality of first abrasive bodies provides a first abrasive surface area SA1 and the plurality of second abrasive bodies provides a second abrasive surface area SA2, and wherein the first abrasive surface area to the second abrasive surface area, SA1/SA2 not greater than 10, or not greater than 9, or not greater than 8, or not greater than 7, or not greater than 6, or not greater than 5.

Embodiment 56. The abrasive article of any of the preceding embodiments, wherein the plurality of abrasive bodies includes a random arrangement of the first abrasive body and the second abrasive body.

Embodiment 57. The abrasive article of any of the preceding embodiments, wherein the plurality of abrasive bodies includes a non-random arrangement of the first abrasive body and the second abrasive body.

Embodiment 58. The abrasive article of any of the preceding embodiments, wherein the plurality of abrasive bodies includes an alternating arrangement of the first abrasive body and the second abrasive body.

Embodiment 59. The abrasive article of any of the preceding embodiments, wherein the abrasive particles of the first abrasive body comprise an oxide, carbide, nitride, boride, diamond.

Embodiment 60. The abrasive article of any of the preceding embodiments, wherein the abrasive particles of the first abrasive body comprise superabrasive particles.

Embodiment 61. The abrasive article of any of the preceding embodiments, wherein the abrasive particles of the first abrasive body comprise diamond.

Embodiment 62. The abrasive article of any of the preceding embodiments, wherein the abrasive particles of the second abrasive body comprise an oxide, carbide, nitride, boride, diamond.

Embodiment 63. The abrasive article of any of the preceding embodiments, wherein the abrasive particles of the second abrasive body comprise superabrasive particles.

Embodiment 64. The abrasive article of any of the preceding embodiments, wherein the abrasive particles of the second abrasive body comprise diamond.

### EXAMPLE

An abrasive article was prepared in the form of a Type 2A2TS wheel utilizing the materials and processes described below.

A plurality of metal-bonded abrasive bodies were formed by initially mixing a powder metal alloy with non-iodized salt (obtained from Shaw's, Inc., Worcester, Mass.) at a weight ratio of 65:35 metal alloy:salt. The salt had a particle size distribution ranging from about 74 to about 210 microns (i.e., coarser than 200 U.S. Mesh and finer than 70 U.S. Mesh).

The powder metal alloy included a blend of approximately 40-45 wt % copper powder (Dendritic FS grade, particle size −325 mesh, obtained from Sintertech International Marketing Corp., Ghent, N.Y.), approximately 4-10 wt % phosphorus/copper powder (grade 1501, particle size −325 mesh, obtained from New Jersey Zinc Company, Palmerton, Pa.), and approximately 47-53 wt % weight percent tin powder (grade MD115, particle size −100/+325 mesh, 0.5% maximum, obtained from Alcan Metal Powders, Inc., Elizabeth, N.J.).

Approximately 1-4 wt % diamond abrasive, available as Warrant ABC SuperAbrasives micron sized diamond, and having a particle size distribution from about 3 to about 6 microns was added to the metal alloy/salt mixture. The mixture was mixed until it was uniformly blended.

The mixture was then separated into equal portions, and each portion was placed in a graphite mold and hot pressed at approximately 400-410° C. for approximately 8-13 minutes at approximately 20-25 MPa until each body had a target density in excess of 95% of theoretical density. After cooling, each body was immersed in boiling water for approximately 45 minutes in order to remove the salt. The bodies were rinsed with deionized (DI) water. Subsequent weight loss and energy dispersive x-ray (EDX) measurements confirmed that substantially all salt had been removed from the segments. Each of the abrasive bodies had a porosity of approximately 64-69 vol %.

Each of the metal-bonded abrasive bodies had a first content of superabrasive particles (i.e., diamond abrasive particles) of 1-3 vol %, a first content of porosity of 66-70 vol %, a first content of bond material of 28-32 vol % for a total volume of each abrasive body.

Each of the abrasive bodies was ground to the required dimensions and tolerances. The abrasive bodies were affixed to a major surface of the aluminum substrate with Epo-tek 353NDT Amber bonding compound.

A plurality of vitrified-bonded abrasive bodies were formed by initially creating a mixture of diamond abrasive, borosilicate glass frit, alumina glass sphere filler particles, and binder as provided in Table 1 below. It will be appreciated that total weight percent of all components is 100%. The composition of the glass frit is provided in Table 2 below.

TABLE 1

| Material | Description | Quantity (g) |
|---|---|---|
| Diamond | iljin IMPM-EC, 8-12 MICRON | 100-110 |
| Glass frit | Milled Frit of approximately 2-4 | 45-50 |
| | Microns | |
| Alumina spheres | E-Spheres SL75 (Envirospheres) | 10-14 |
| Binder | Carbowax PEG Compound 20M | 22-27 |
| | (purchased from Sigma Aldrich) | |

TABLE 2

| Composition | Amount | |
|---|---|---|
| Al₂O₃ | 1-2 | wt % |
| B₂O₃ | 11-14 | wt % |
| CoO | 1-2 | wt % |
| Fe₂O₃ | 1-2 | wt % |
| K₂O | 3-6 | wt % |
| MnO₂ | 4.6 | wt % |
| Na₂O | 9-11 | wt % |
| SiO₂ | 60-64 | wt % |

The frit included less than 1 wt % for each of BaO, CaO, CuO, HfO₂, Li₂O, La₂O₃, MgO, NiO, SrO, TiO2, YsO₃, ZnO, and ZrO₂. The sum of the components in the frit was 100%.

The mixture is then pressed to form one or more abrasive green bodies at 25 tons, which corresponds to a pressure of approximately 2500-2700 psi. The body is then fired at a maximum firing temperature between approximately 680-720° C. for approximately 200-220 minutes in a standard atmosphere. Each of the vitrified-bonded abrasive bodies had a first content of superabrasive particles (i.e., diamond abrasive particles) of 18-22 vol %, a first content of porosity of at least 54-58 vol % a first content of bond material of 10-14 vol % and a first content of a filler of 6-12 vol % for a total volume of each abrasive body.

The vitrified-bonded abrasive bodies had approximately the same dimensions as the metal-bonded abrasive bodies and were attached to the substrate using Araldite 2014 & 2014/A Hardener. The vitrified-bonded and metal-bonded abrasive bodies were arranged in a radially-alternating arrangement relative to each other as provided in FIG. 1.

An example abrasive article and a comparative example abrasive article were prepared according to the above methods. The example abrasive article had a wear rate differential of about 0.2-0.3 cc. The comparative example had a wear rate differential of greater than 0.45 cc. The usable lifespan of the comparative example was significantly less than the usable lifespan of the example.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Reference herein to a material including one or more components may be interpreted to include at least one embodiment wherein the material consists essentially of the one or more components identified. The term “consisting essentially” will be interpreted to include a composition including those materials identified and excluding all other materials except in minority contents (e.g., impurity contents), which do not significantly alter the properties of the material. Additionally, or in the alternative, in certain non-limiting embodiments, any of the compositions identified herein may be essentially free of materials that are not expressly disclosed. The embodiments herein include range of contents for certain components within a material, and it will be appreciated that the contents of the components within a given material total 100%.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any sub combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. An abrasive article comprising:
a substrate comprising a first surface;
a plurality of abrasive bodies attached to the first surface, wherein the plurality of abrasive bodies comprises:
a first abrasive body; and
a second abrasive body, wherein the first abrasive body and second abrasive body have at least one abrasive characteristic that are different, wherein the abrasive characteristic is selected from the group of bond composition, bond content, porosity content, pore size distribution, average pore size, average abrasive particle size, abrasive particle composition, or any combination thereof.

2. The abrasive article of claim 1, wherein the first abrasive body comprises:
a first content of superabrasive particles of at least 12 vol % and not greater than 28 vol % for a total volume of the first abrasive body;
a first content of porosity of at least 52 vol % and not greater than 68 vol % for a total volume of the first abrasive body; and
a first content of bond material of at least 6 vol % and not greater than 18 vol % for a total volume of the first abrasive body, wherein the bond material comprises a vitreous material.

3. The abrasive article of claim 1, wherein the abrasive article comprises:
a wear rate differential between the first abrasive body and second abrasive body of at least 0.08 cc and not greater than 1.0 cc; or
an average compressive stress at maximum load of at least 50 MPa and not greater than 500 MPa.

4. The abrasive article of claim 1, wherein the abrasive article comprises a wear rate differential between the first abrasive body and second abrasive body of at least 0.08 cc.

5. The abrasive article of claim 1, wherein the abrasive article comprises a wear rate differential between the first abrasive body and second abrasive body of not greater than 1.0 cc.

6. The abrasive article of claim 1, wherein the abrasive article comprises an average compressive stress at maximum load of at least 50 MPa.

7. The abrasive article of claim 1, wherein the abrasive article comprises an average compressive stress at maximum load of not greater than 500 MPa.

8. The abrasive article of claim 1, wherein the first abrasive body comprises a wear rate index of at least 0.08 cc.

9. The abrasive article of claim 1, wherein the first abrasive body comprises a wear rate index of not greater than 1.0 cc.

10. The abrasive article of claim 1, wherein the first abrasive body comprises a vitreous bond material.

11. The abrasive article of claim 1, wherein the second abrasive body comprises a non-vitreous bond material.

12. The abrasive article of claim 1, wherein the second abrasive body comprises a metal bond material.

13. The abrasive article of claim 1, wherein the plurality of abrasive bodies includes an alternating arrangement of the first abrasive body and the second abrasive body.

14. The abrasive article of claim 1, wherein the second abrasive body comprises a wear rate index of at least 0.25 cc.

15. The abrasive article of claim 1, wherein the second abrasive body comprises a wear rate index of not greater than 1.0 cc.

16. The abrasive article of claim 1, wherein the wear rate differential between the first abrasive body and the second abrasive body is not greater than 50% of the larger wear rate index.

17. An abrasive article comprising:
a first abrasive body coupled to a substrate, wherein the first abrasive body comprises abrasive particles including a superabrasive and a bond material comprising a vitreous material;
a second abrasive body coupled to the substrate, wherein the second abrasive body comprises abrasive particles including a superabrasive and a bond material comprising at least one non-vitreous phase material; and
a wear rate differential between the first abrasive body and second abrasive body of at least 0.08 cc.

18. The abrasive article of claim 17, wherein the first abrasive body comprises a wear rate index of at least 0.08 cc.

19. The abrasive article of claim 17, wherein the second abrasive body comprises a wear rate index of at least 0.25 cc.

20. An abrasive article comprising:
a first abrasive body coupled to a substrate, wherein the first abrasive body comprises:
a first content of superabrasive particles of at least 10 vol % and not greater than 30 vol % for a total volume of the first abrasive body;
a first content of porosity of at least 50 vol % and not greater than 70 vol % for a total volume of the first abrasive body;
a first content of bond material of at least 5 vol % and not greater than 20 vol % for a total volume of the first abrasive body, wherein the bond material comprises a vitreous material; and
a second abrasive body coupled to the substrate, wherein the second abrasive body comprises:
a bond material comprising metal; and
at least one of:
a second content of superabrasive particles in the second abrasive body different from the first content of superabrasive particles of the first abrasive body;
a second content of porosity in the second abrasive body that is different from the first content of porosity of the first abrasive body; or
a second content of bond material in the second abrasive body that is different from the first content of bond material of the first abrasive body.
